(19) United States
(12) Patent Application Publication
(10) Pub. No.: US 2004/0117621 A1
(43) Pub. Date: Jun. 17, 2004

(54) System and method for managing resource sharing between computer nodes of a network

(76) Inventor: Erik A. Knight, Dallas, TX (US)

Correspondence Address: BAKER BOTTS L.L.P., 2001 ROSS AVENUE, SUITE 600, DALLAS, TX, 75201-2980, US

(21) Appl. No.: 10/318,330

(22) Filed: Dec. 12, 2002

(51) Int. Cl. H04L 9/00; G06F 15/173

(52) U.S. Cl. 713/165; 709/226

(57) ABSTRACT

According to one embodiment of the invention, a system for resource sharing includes a plurality of computer nodes associated with a network, each computer node including one or more electronic files, one or more hardware resources, an encryption utility operable to encrypt the electronic files that are stored in a respective searchable directory, a search utility operable to create a respective index file representing the respective electronic files that are stored in the respective searchable directory, and a computing utility operable to allocate a portion of at least one of the hardware resources for use by other computer nodes. The system further includes a network managing node coupled to the plurality of computer nodes and operable to detect the hardware resource allocations from the computer nodes, prioritize the hardware resource allocations into one or more pools, store the pools in the directory service server, monitor communication between the computer nodes, and store a plurality of communication characteristics representing the communication between the computer nodes. The system further includes an encryption service server coupled to the plurality of computer nodes and operable to store respective public keys associated with the respective searchable directories.

### BACKGROUND OF THE INVENTION

Personal computers (“PC's”) nowadays are very powerful. They are also very expensive and, as such, businesses desire to maximize their efficiency so that they can succeed in the competitive business world with minimal capital expense for PC's and other computing devices.

Businesses also utilize computer networks to maximize efficiency of computers. Because of an increasing use of computer networks, large businesses, and other enterprises, have a myriad of information in electronic form that is typically stored on multiple PC's that are distributed globally. Much of this information important, as well as sometimes being sensitive and/or confidential.

Various vendors have addressed different issues related to sharing resources or information on a network. There are products that allow for the encryption of data on harddrives, that enable secure encrypted communications links between computers, and that allow computers to share computing resources. However, these products only address such issues at the server level in a client-server environment.

### SUMMARY OF THE INVENTION

According to one embodiment of the invention, a system for resource sharing includes a plurality of computer nodes associated with a network, each computer node including one or more electronic files, one or more hardware resources, an encryption utility operable to encrypt the electronic files that are stored in a respective searchable directory, a search utility operable to create a respective index file representing the respective electronic files that are stored in the respective searchable directory, and a computing utility operable to allocate a portion of at least one of the hardware resources for use by other computer nodes. The system further includes a network managing node coupled to the plurality of computer nodes and operable to detect the hardware resource allocations from the computer nodes, prioritize the hardware resource allocations into one or more pools, store the pools in the directory service server, monitor communication between the computer nodes, and store a plurality of communication characteristics representing the communication between the computer nodes. The system further includes an encryption service server coupled to the plurality of computer nodes and operable to store respective public keys associated with the respective searchable directories.

According to another embodiment of the invention, a method for managing resource sharing between a plurality of computer nodes of a network includes detecting a plurality of access rights from the computer nodes, modifying the access rights, storing the modified access rights in a directory service server, detecting a plurality of hardware resource allocations from the computer nodes, prioritizing the hardware resource allocations into one or more pools, and storing the pools in the directory service server. The method may further include monitoring communication between the computer nodes and storing a plurality of communication characteristics representing the communication between the computer nodes.

Embodiments of the invention provide a number of technical advantages. Embodiments of the invention may include all, some, or none of these advantages. A network implemented with one embodiment of the present invention allows centralized enterprise management of peer-to-peer relationships in a secure manner. Also, a user of one PC is able to find desired information on another user's PC because of the ability to search an index file that represents the information stored on that other user's PC. In this way, important, untapped information may not go unused. This information is also encrypted on the other user's PC such that the user who desires the information must be verified by the enterprise manager before getting access to the part of the encryption key that is able to decrypt the information.

In addition to information being shared between peers, computer resources may also be shared. For example, a user may allow some portion of his PC's power to be available for other users. The enterprise manager may then allocate this power to other users who may need to utilize that power for a particular purpose. Other computer resources, such as cache and hard drive space may also be shared.

Other technical advantages are readily apparent to one skilled in the art from the following figures, descriptions, and claims.

### BRIEF DESCRIPTION OF THE DRAWINGS

For a more complete understanding of the invention, and for further features and advantages, reference is now made to the following description, taken in conjunction with the accompanying drawings, in which:

FIG. 1 is a block diagram illustrating a system for managing resource sharing between computer nodes of a network in accordance with one embodiment of the present invention;

FIG. 2 is a block diagram illustrating a computer node of the network of FIG. 1 in accordance with one embodiment of the present invention;

FIG. 3 is a block diagram illustrating a network managing node of the network of FIG. 1 in accordance with one embodiment of the present invention; and

FIGS. 4 through 6 are flowcharts illustrating various methods for managing resource sharing between computer nodes of a network in accordance with some embodiments of the present invention.

### DETAILED DESCRIPTION OF EMBODIMENTS OF THE INVENTION

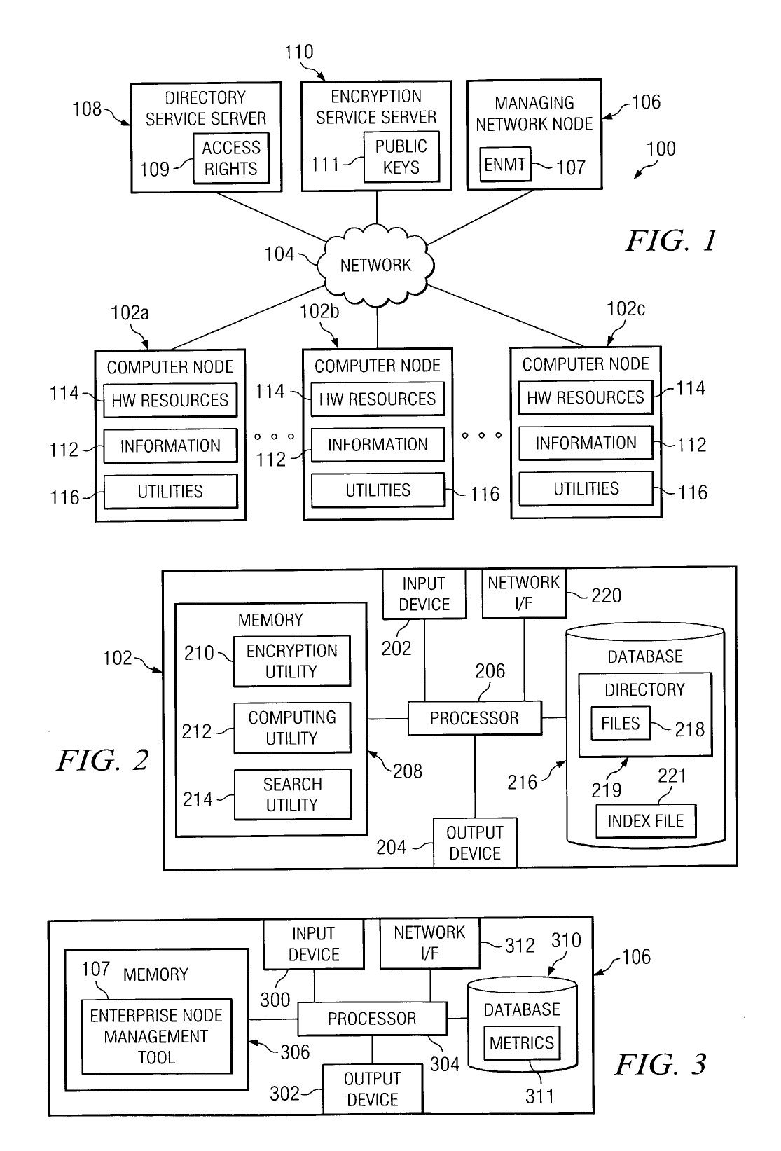

Embodiments of the present invention and their advantages are best understood by referring now to FIGS. 1-6 of the drawings, in which like numerals refer to like parts.

FIG. 1 is a block diagram illustrating a system 100 for managing resource sharing between a plurality of computer nodes 102 associated with a network 104 assisted by a network managing node 106 in accordance with one embodiment of the present invention. System 100 also includes a directory service server 108 storing access rights 109 and an encryption service server 110 storing a plurality of public keys 111. Different components or a greater or lesser number of components associated with system 100 are contemplated by the present invention. System 100 generally illustrates an example enterprise, in which the enterprise is defined as any group of peers that get together for a particular purpose and desire to share resources. For example, system 100 may represent a large corporation, a joint venture, a consortium, or any other suitable enterprise.

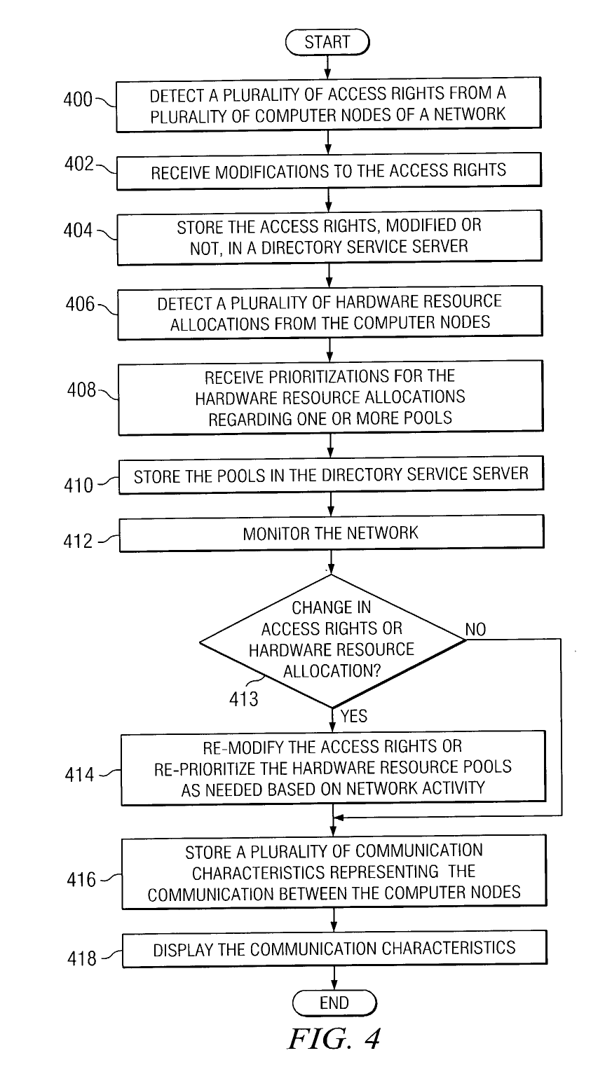

In the example enterprise illustrated in FIG. 1, computer nodes 102, which are described in greater detail below in conjunction with FIG. 2, are suitable personal computers that have resources that often go untapped or, at the very least, are not efficiently utilized. For example, computer nodes 102 may have a myriad of information 112 and various hardware resources 114 associated therewith. Information 112 and hardware resources 114 typically are underutilized in an enterprise. The present invention addresses this problem, and others, by providing an enterprise node management tool 107 associated with network managing node 106 to manage and monitor resource sharing between computer nodes 102. In addition, each computer node 102 has resource sharing utilities 116 that may work in conjunction with enterprise node management tool 107 to help facilitate the resource sharing between computer nodes 102.

Network 104 couples computer nodes 102, network managing node 106, directory service server 108, and an encryption service server 110 together. The term “couples” refers to any direct or indirect communication between two or more components, whether or not these components are in physical contact with one another. Network 104 facilitates communication between all of the components of system 100. For example, network 104 may communicate Internet Protocol (“IP”) packets, frame relay frames, Asynchronous Transfer Mode (“ATM”) cells, or other suitable information between the components of system 100. Network 104 may include one or more local area networks (“LANs”), metropolitan area networks (“MANs”), wide area networks (“WANs”), all or a portion of a global computing network such as the Internet, or any other suitable communication system or systems at one or more locations. As a few examples, network 104 may be a virtual private network (“VPN”), one or more extranets, or any other suitable public or private network or any combination thereof.

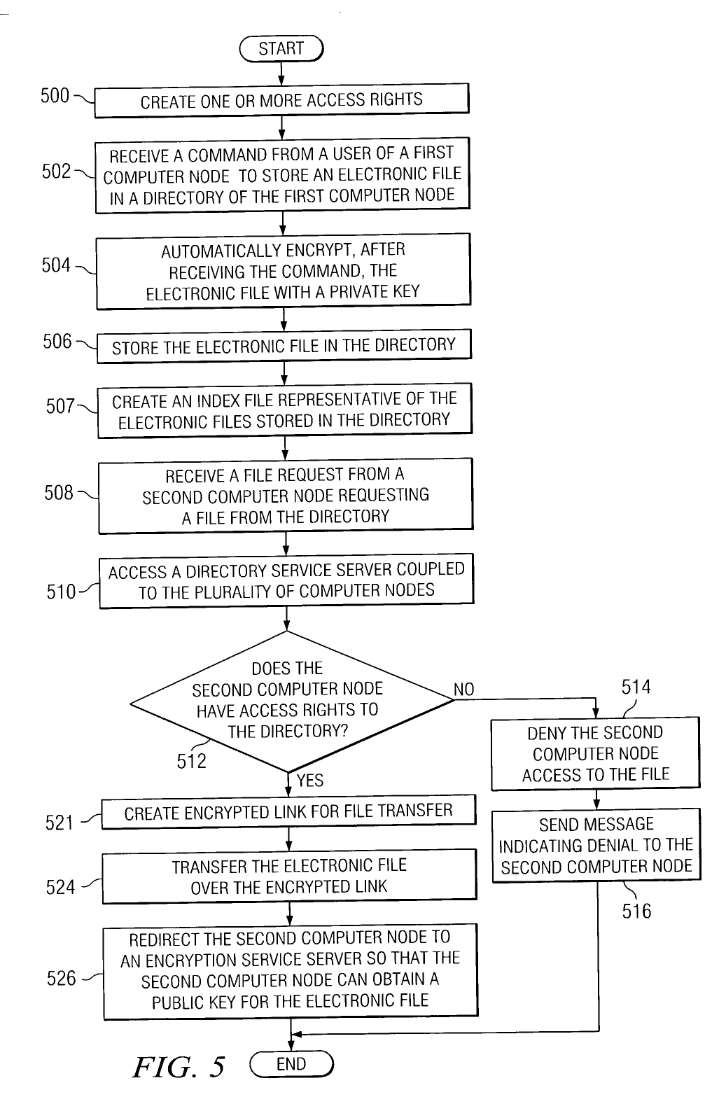

Network managing node 106 is any suitable computer, such as a personal computer or server, housing enterprise node management tool 107 that generally functions to manage and monitor communication and resource sharing between computer nodes 102. Network managing node 106 is described in greater detail below in conjunction with FIG. 3. Although only one network managing node 106 is illustrated, the functionality of enterprise node management tool 107 may be distributed among multiple network managing nodes 106. Enterprise node management tool 107, which is also described in further detail below in conjunction with FIG. 3, generally allows complex relationships between computer nodes 102 to be centrally managed across network 104 and to graphically display metrics regarding the communication and resource sharing between computer nodes 102. This functionality is described in greater detail below in conjunction with FIG. 3.

Directory service server 108 is a server or other suitable computing device that functions to provide a directory service to system 100, as described below. For example, directory service server 108 may be a lightweight directory access protocol (“LDAP”) server, Active Directory server, or other suitable directory service server. Directory service server 108 may include any suitable hardware, software, firmware, or any combination thereof operable to perform its directory service. Although only one directory service server 108 is illustrated, the directory service function may be spread among multiple servers in one or more locations. Directory service server 108, at the very least, will include a database storing one or more access rights 109. The database may use any of a variety of directory trees, data structures, arrangements, and compilations to store and facilitate retrieval of access rights 109. Access rights 109, which are described in greater detail below, indicate access rights for each of the computer nodes 102. In other words, access rights 109 indicate which computer nodes have access to other computer nodes' resources. For example, a computer node 102a may have access to a particular directory of a computer node 102b but not other directories associated with computer node 102b. Access rights 109 are initially given by each computer node 102; however, network managing node 106 may receive those access rights and modify them according to the needs of the enterprise. These modified access rights are then stored in directory service server 108.

Encryption service server 110 is any server or other suitable computing device that functions to provide an encryption service to system 100. Encryption service server 110 may include any suitable hardware, software, firmware, or any combination thereof operable to provide its function as an encryption service. For example, encryption service server 110 may be a PKI server, a digital certificate system server, or any other suitable encryption service server. Encryption service server 110, at the very least, includes a database storing one or more public keys 111 for use by the enterprise. Public keys 111, which are described in greater detail below, function to decrypt encrypted information sent from one computer node 102 to another computer node 102. A particular computer node 102 would not be able to obtain a particular public key 111 unless that computer node 102 has successfully logged into network 104 and has access rights to that particular directory from which the encrypted information came from. The computer node 102 that is transmitting the encrypted information typically uses a private key to encrypt the information.

In one aspect of operation of system 100, users of computer nodes 102 give access rights to users of other computer nodes 102 to their respective information 112 and/or hardware resources 114. Because network managing node 106 is monitoring the network activity of computer nodes 102, it detects these access rights and is able to manage and/or modify these access rights according to the particular needs of the enterprise. These access rights are then stored in directory service server 108. When a user of a particular computer node, such as computer node 102a, desires information on a particular subject, he or she may initiate a search for electronic files that satisfy the desired information. The user of computer node 102a is only able to access the directories of other computer nodes 102 if it has access rights 109 to those directories.

For example, a user of computer node 102b may receive a file request from computer node 102a. The user of computer node 102b then accesses directory service server 108 to determine whether the user of computer node 102a has access rights to any of computer node's 102b directories. Assuming that the user of computer node 102a has access rights to some of the directories of computer node 102b, then the user of computer node 102a is allowed access to files in those respective directories of computer node 102b and may obtain the desired electronic file. However, this electronic file is in encrypted format because, according to the teachings of one embodiment of the invention described more fully below, electronic files stored in “searchable” directories are encrypted. Therefore, the user of computer node 102a needs the associated public key 111 for that particular electronic file to decrypt the file. Computer node 102a is then redirected by computer node 102b to encryption service server 110 to obtain the associated public key 111 so that the user may decrypt the file and use the information contained therein. Having one-half of the encryption key on encryption service server 110 assures that no one using a particular computer node 102 can access encrypted information 112 on that particular computer node 102 unless computer node 102 is successfully logged into network 104. This prevents someone from removing the hard drive from computer node 102 and accessing information 112 directly. Other operations of system 100 are described below.

FIG. 2 is a block diagram of a computer node 102 in accordance with one embodiment of the present invention. In the illustrated embodiment, computer node 102 includes an input device 202, an output device 204, a processor 206, a memory 208 storing encryption utility 210, a computing utility 212, and a search utility 214, a database 216 storing files 218, and a network interface 220.

Input device 202 is coupled to computer node 102 for the purpose of inputting information, such as information 112, commands, or other suitable inputs. In one embodiment, input device 202 is a keyboard; however, input device 202 may take other forms, such as a mouse, a stylus, or a scanner. Output device 204 is any suitable visual display unit, such as an LCD, or CRT display. Output device 204 may also be coupled to a printer (not shown) for the purpose of printing out any desired information.

Processor 206 comprises any suitable processing unit that executes logic. One of the functions of processor 206 is to retrieve and execute applications, utilities, tools, or other computer software stored in memory 208. For example, processor 206 may function to retrieve encryption utility 210, computing utility 212, and search utility 214 from memory 208 and execute them at the appropriate time. Processor 206 may also control the receiving and storing of information, such as information 112, and files 218 in database 216 or other suitable storage location. Processor 206 may have other suitable functions.

Memory 208 and database 216 may comprise files, stacks, databases, or other suitable organizations of volatile or nonvolatile memory. Memory 208 and database 216 may be random access memory, read only memory, CD-ROM, removable memory devices, or any other suitable devices that allow storage and/or retrieval of data. Memory 208 and database 216 are interchangeable and may perform the same functions. One of the functions of memory 208 is to store encryption utility 210, a computing utility 212, and search utility 214 or other suitable utilities.

Encryption utility 210 is any suitable computer program or routine written in any suitable computer language that is operable, in one embodiment, to encrypt files 218 that are stored in a searchable directory 219. Encryption utility 210 may also be operable to transmit electronic files 218 in encrypted format over an encrypted link. Further details of encryption utility 210 are described below in conjunction with FIG. 5.

Computing utility 212 is a computer program or routine written in any suitable computer language that is operable, in one embodiment, to allocate, at the direction of a user, a portion of a hardware resource 114 of computer node 102 for use by other computer nodes 102. Hardware resources 114 may be any suitable hardware resource of computer node 102, such as processor 206, memory 208, cache (not shown), and database 216. Any suitable hardware resource of computer node 102 that may be shared between other computer nodes 102 is contemplated by the present invention. Details of computing utility 212 are described below in conjunction with FIG. 6.

Search utility 214 is a computer program or routine written in any suitable computer language that is operable, in one embodiment, to create one or more index files 221 that represent electronic files 218 stored in searchable directory 219. Index file 221 is created by search utility 214 to make searching easier, faster, and more efficient by eliminating the need to search the complete hard drive of a particular computer node 102. Search utility 214 may have other suitable functions, such as a search engine function to facilitate the keyword searching of electronic files 218 stored on other computer nodes 102. Details of search utility 214 are described below in conjunction with FIG. 5.

Encryption utility 210, computing utility 212, and search utility 214 may be written in any portable computer code that allows them to be easily recompiled for different operating systems or hardware architectures for computer nodes 102. For example, computer nodes 102 may have different operating systems, such as Windows NT, UNIX, LINUX, AIX, or other suitable operating systems. Utilities 210, 212, and 214 are written such that they may be executed using any suitable operating system. In the illustrated embodiment, utilities 210, 212, and 214 are logic encoded in memory 208. However, in alternative embodiments, utilities 210, 212, and 214 may be implemented through application specific integrated circuits (“ASICs”), field programmable gate arrays (“FPGAs”), digital signal processors (“DSPs”), or other suitable specific or general purpose processors.

Electronic files 218 are any suitable electronic files that are stored in one or more searchable directories 219. A user of a particular computer node 102 may indicate one or more directories that may be searchable by other computer nodes 102 and these searchable directories 219 store electronic files 218 that may be accessed by other computer nodes 102. Electronic files 218 stored in searchable directories 219 are in encrypted format via encryption utility 210. One or more index files 221 represent the electronic files 218 stored in searchable directories 219. Index files 221 are created using search utility 214, as described above.

Network interface 220 functions to allow a computer node 102 to communicate with other computer nodes 102 of network 104 in order to transmit and receive information. In one embodiment, network interface 220 is a network interface card; however, network interface 220 may be other devices suitable for receiving and transmitting signals, such as a modem or a digital subscriber line.

FIG. 3 is a block diagram illustrating network managing node 106 in accordance with one embodiment of the present invention. In the illustrated embodiment, network managing node 106 includes an input device 300, an output device 302, a processor 304, a memory 306 storing enterprise node management tool 107, database 310 storing metrics 311, and network interface 312.

Input device 300 is coupled to network managing node 106 for the purpose of inputting information, such as modified access rights, pools of available hardware resources, prioritizations of hardware resources, or other suitable information. In one embodiment, input device 300 is a keyboard; however, input device 300 may take other forms, such as a mouse, a stylus, or a scanner. Output device 302 may be any suitable visual display unit, such as an LCD or CRT display. Output device 302 may also be coupled to a printer (not shown) for the purpose of printing out any desired information, such as metrics 311 obtained as a result of the managing and monitoring of the communication between computer nodes 102.

Processor 304 comprises any suitable processing unit that executes logic. One of the functions of processor 304 is to retrieve enterprise node management tool 107 from memory 306 and execute it at the appropriate time. Processor 304 may also control the receiving and storing of information in database 310 or other suitable storage location. Processor 304 may have other suitable functions, such as executing other applications stored in memory 306.

Memory 306 and database 310 may comprise files, stacks, databases, or other suitable organizations of volatile or nonvolatile memory. Memory 306 and database 310 may be random access memory, read only memory, CD-ROM, removable memory devices, or any other suitable devices that allow storage and/or retrieval of data. Memory 306 and database 310 are interchangeable and may perform the same functions. One of the functions of memory 306 is to store enterprise node management tool 107.

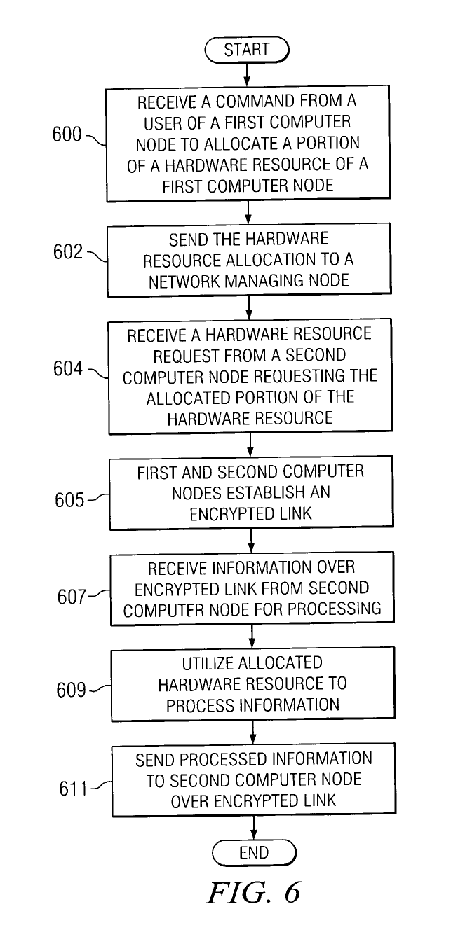

Enterprise node management tool 107 is a computer program or any number of computer programs written in any suitable computer language that is operable, in some embodiments, to monitor and manage communication between computer nodes 102 of the enterprise. These functions and other functions of enterprise node management tool 107 are described in greater detail below in conjunction with FIG. 4. In the illustrated embodiment, enterprise node management tool 107 is logic encoded in memory 306. However, in alternative embodiments, enterprise node management tool 107 is implemented through ASICs, FPGAs, DSPs, or other suitable specific or general purpose processors.

Metrics 311 are created using enterprise node management tool 107 or other suitable computer program(s) stored in memory 306 and executed by processor 304. Metrics 311 may include any types of files, such as text files, graphics files, video files, or other suitable files. Metrics 311 may be stored in database 310 and/or displayed on output device 302, preferably with a graphical user interface (“GUI”), to allow a user of network managing node 106 to monitor and/or manage the communication between computer nodes 102. As an example, a GUI may display metrics 311, such as peer-to-peer relationships, available resources and current usage of all managed resources. More specifically, metrics 311 may include such things as which computer node 102 has accessed what type of information 112 of other computer nodes 102, when that particular node 102 accessed the information and for how long, a list of access rights 109 for each computer node 102, a list of all searchable directories 219 of the computer nodes 102, a list of available hardware resources 114 available for use by other computer nodes 102, information on pools of hardware resources 114 that are available and which computer nodes 102 are assigned to those available hardware resources 114, or other suitable metrics associated with the network usage by computer nodes 102. Metrics 311 may be used by the user of network managing node 106 for later analysis, such as analyzing historical records and network usage patterns, identifying underutilized resources, and reallocating resources or otherwise maximizing network resources and improving the efficiency of network usage.

Network interface 312 functions to allow computer node 102 to communicate with other computer nodes 102 of network 104 in order to transmit and receive information. In one embodiment, network interface 312 is a network interface card; however, network interface 312 may be other devices suitable for receiving and transmitting signals, such as a modem or a digital subscriber line.

FIG. 4 is a flowchart illustrating a method for managing resource sharing between computer nodes 102 of network 104 according to one embodiment of the present invention. The method outlined in FIG. 4 illustrates some of the functionality of enterprise node management tool 107 of network managing node 106. The method begins at step 400 where a plurality of access rights 109 are detected from computer nodes 102 of network 104. As described above, access rights 109 are given by the users of each computer node 102. The ability of a user of a computer node 102 to give access rights to other users of other computer nodes 102 is well known in the art of network computing.

Since network managing node 106 is continuously monitoring network activity, then network managing node 106 may detect the access rights 109 given by computer nodes 102 to users of other computer nodes 102. Network managing node 106 may also receive, via enterprise node management tool 107, access rights 109 via a directory tree or other suitable format from directory service server 108. At step 402, modifications to access rights 109 are received by enterprise node management tool 107. A user of network managing node 106 may enter any required modifications to access rights 109 using input device 300 of network managing node 106. Access rights 109 may be modified for any number of reasons. For example, referring to FIG. 1, computer node 102b may be associated with a particular group of the enterprise. It may be desired that the user of computer node 102b should not be able to see any information 112 on computer node 102a. If the user associated with computer node 102a gives access rights to the user of computer node 102b, then network managing node 106, knowing that the user of computer node 102b should not be able to see any information 112 on computer node 102a, may modify those access rights to exclude the user of computer node 102b from access to computer node 102a. Modified access rights or the access rights 109 unmodified are stored, at step 404, in directory service server 108.

A plurality of hardware resource allocations are detected, at step 406, from computer nodes 102. Similar to access rights 109 above, the users of computer nodes 102 may allocate a portion of at least one of the hardware resources 114 associated with that computer node 102 so that other computer nodes 102 in network 104 may be able to utilize that portion of the hardware resource 114. Since network managing node 106 is monitoring network activity, enterprise node management tool 107 detects these allocations automatically. The user associated with network managing node 106 has the ability to prioritize the hardware resource allocations into one or more pools. In one embodiment, prioritizing the hardware resources 114 of computer nodes 102 is done in a subjective manner by the user of network managing node 106. He or she may base their decisions on the efficiency of the enterprise. For example, the user of network managing node 106 may desire to allocate hardware resources 114 of certain computer nodes 102 to the accounting department at a certain time of day because he or she knows that the accounting department runs invoices at that time and needs a lot of computing power to perform that task. Instead of having to buy larger computers with more power for the accountants in the accounting department, hardware resources 114 of other computer nodes 102 in network 104 may be efficiently utilized via these allocations from other computer nodes 102. As another example, another pool may be prioritized for the engineering department when the engineering department requests a specific time of day in which they wish to run engineering calculations for a specific application that requires a lot of computing power. The prioritizations by the user of network managing node 106 may take any suitable form. In another embodiment, enterprise node management tool 107 automatically prioritizes the hardware resource allocations into one or more pools based on predetermined rules set up by the user of network managing node 106. In any event, the prioritizations are received at step 408 by enterprise node management tool 107. The pools are subsequently stored in directory service server 108 at step 410.

Having a network managing node 106 that manages all computer nodes 102 of a network 104 maximizes the efficiency of the resources of each computer node 102 of the enterprise. Typically, many of the resources associated with computer nodes of a network, such as critical information or hardware resources, go untapped. Network managing node 106 may centrally manage the sharing of resources between computer nodes 102 to maximize the efficiency of computer nodes 102 of the enterprise, which saves considerable time and money for the enterprise. Network managing node 106 is able to centrally manage resource sharing between users of computer nodes 102 of network 104 by continuously monitoring network 104, as denoted by step 412.

If it is determined at decisional step 413 that access rights 109 and/or hardware resource 114 allocations have changed, then access rights 109 may be re-modified and/or hardware resource 114 allocations may be re-prioritized, at step 414, as needed based on network activity. For example, a user of a particular computer node 102 may withdraw or change one or more access rights 109 or may withdraw his or her shared hardware resource 114 from the processing pool. Or there may be laws, standards, or in-house rules that may determine that one user of a particular computer node 102 may not have access to the information on another computer node 102. Therefore, access rights 109 may have to be modified and/or pools of hardware resource allocations may have to be reprioritized. In addition, employees of the enterprise may leave the company and new ones may receive that person's personal computer. Access rights 109 may then have to be modified for that reason. There are other suitable reasons why access rights 109 may have to be re-modified and/or hardware resource allocations 114 may have to be re-prioritized.

Network managing node 106 stores a plurality of communication characteristics representing the communication between computer nodes 102 and network 104 at step 416. The communication characteristics may be displayed at step 418. The communication characteristics allows the user of network managing node 106 to make educated decisions about the resource sharing between computer nodes 102 of network 104.

FIG. 5 is a flowchart illustrating another method for managing resource sharing between computer nodes 102 of network 104 in accordance with one embodiment of the present invention. The method outlined in FIG. 5 outlines some of the functionality of both encryption utility 210 and search utility 214 of a representative computer node 102. The method begins at step 500 where one or more access rights 109 are created by a user of a first computer node. At step 502, a command from the user of the first computer node 102 to store an electronic file in a directory of the first computer node is received. After receiving the command, the electronic file is automatically encrypted with a private key at step 504. The directory that the electronic file is stored in is a searchable directory that the user of first computer node 102 may use to store electronic files that they wish to share with other users of other computer nodes 102. Directing an electronic file into this searchable directory automatically causes, via encryption utility 210, the electronic file to be encrypted with a private key associated with first computer node 102b. Electronic files are stored in the searchable directory at step 506. There may be more than one searchable directory associated with each computer node 102b. For example, there may be one directory designated for a certain group of users, while another directory is designated for another group of users. At step 518, an index file 221 is created by search utility 214 of first computer node 102b that is representative of all the electronic files stored in the directory desired to be searched.

A file request is received from a user of a second computer node 102, at step 508, requesting a file from the searchable directory. The file request may take any suitable form. For example, the search request may come via a system message block, a text message, an email, a voicemail message, or other suitable manner. Upon receiving the file request from second computer node 102, the user of first computer node 102 accesses directory service server 108 to determine whether the user of second computer node 102 has access rights 109 to that directory, which is indicated by decisional step 512. One of the reasons that the user of first computer node 102 has to check access rights 109 in directory service server 108 is that the user associated with network managing node 106 may have modified the access rights 109 originally given by the user of first computer node 102 to the user of second computer node 102. If the user of second computer node 102 does not have access rights 109 to that directory of first computer node 102, then access to the file stored in that directory is denied at step 514. Thereafter, a message is sent to the user of second computer node 102 that indicates the denial of the file access at step 516. The method then ends. The denial message may take any suitable form, such as a system message block, a text message, a voice message, or other suitable manner.

If the user of second computer node 102 has access rights 109 to the directory, then an encrypted link is created, as denoted by step 521, so that the file may be transferred in encrypted format over the encrypted link, as denoted by step 524. Since the electronic file is encrypted, the user of the second computer node 102 is redirected to encryption service server 110, at step 526, so that the user of the second computer node 102 may obtain a public key to decrypt the electronic file. The method then ends.

FIG. 6 is a flowchart illustrating another method for managing resource sharing between computer nodes 102 of network 104 in accordance with one embodiment of the present invention. The method outlined in FIG. 6 illustrates some of the functionality of both encryption utility 210 and computing utility 212. The method begins at step 600 where a command from a user of a first computer node 102 to allocate a portion of a hardware resource 114 is received. The hardware resource may be such things as a portion of the central processing unit, a memory, a cache, a hard drive, or other suitable hardware resource of computer node 102. The hardware resource allocation is sent, at step 602, to network managing node 106. This allows the user of network managing node 106 to prioritize the hardware resource allocation into one or more pools, as described above.

At step 604, a hardware resource request is received from a second computer node requesting the allocated portion of the hardware resource 114. This hardware resource request is received by first computer node because the user of network managing node 106 has placed the allocated portion of the hardware resource into a pool that the second computer node is allowed access to. The first and second computer nodes 102 then establish an encrypted link between one another, as denoted by step 605. Information is then received by the first computer node from the second computer node over the encrypted link in order for the allocated hardware resource of the first computer node to be utilized for processing the information as needed, as denoted by step 609. The processing may take on any suitable form, such as running calculations, storing data, or other suitable processing depending on the hardware resource that is allocated. The processed information is then sent to the second computer node over the encrypted link at step 611, thereby ending the method outlined in FIG. 6. Because network managing node is monitoring network activity, the hardware resource sharing may be halted, locked, or otherwise controlled by the user of network managing node 106 via enterprise node management tool 107.

Although embodiments of the invention and their advantages are described in detail, a person skilled in the art could make various alterations, additions, and omissions without departing from the spirit and scope of the present invention as defined by the appended claims.

What is claimed is:

1. A system for resource sharing, comprising:
a plurality of computer nodes associated with a network, each computer node comprising:
one or more electronic files;
one or more hardware resources;
an encryption utility operable to encrypt the electronic files that are stored in a respective searchable directory;
a search utility operable to create a respective index file representing the respective electronic files that are stored in the respective searchable directory; and
a computing utility operable to allocate a portion of at least one of the hardware resources for use by other computer nodes;
a network managing node coupled to the plurality of computer nodes and operable to:
detect the hardware resource allocations from the computer nodes;
prioritize the hardware resource allocations into one or more pools;
store the pools in the directory service server;
monitor communication between the computer nodes; and
store a plurality of communication characteristics representing the communication between the computer nodes; and
an encryption service server coupled to the plurality of computer nodes and operable to store respective public keys associated with the respective searchable directories.

2. The system of claim 1, wherein a first computer node of the plurality of computer nodes is operable to:
receive a search request from a second computer node of the plurality of computer nodes, the search request requesting a first electronic file from a first searchable directory of the first computer node;
access the directory service server;
identify, by the directory service server, that the second computer node has access rights to the first searchable directory;
redirect the second computer node to the encryption service server so that the second computer node can obtain a first public key for the first searchable directory; and
allow the second computer node access to the requested first electronic file in the first searchable directory.

3. The system of claim 1, wherein the one or more hardware resources are selected from the group consisting of a central processing unit, a memory, a cache, and a hard drive.

4. The system of claim 1, wherein the network managing node is further operable to:
detect a plurality of access rights from the computer nodes;
modify the access rights; and
store the modified access rights in a directory service server coupled to the plurality of computer nodes.

5. The system of claim 4, wherein the modified access rights are indicative of which computer nodes have access to which respective searchable directories on other computer nodes.

6. The system of claim 1, wherein the network managing node is further operable to assign one or more of the computer nodes to a particular pool during a specified time period.

7. The system of claim 1, wherein a communication characteristic is selected from the group consisting of the identity of two computer nodes communicating with each other, the identity of two computer nodes that have communicated, the identity of a first computer node using the hardware resource of a second computer node, a time period representing how long a first computer node used a second computer node's hardware resource, a list of searchable directories, a list of access rights, and a list of available hardware resources.

8. The system of claim 1, wherein the network managing node is further operable to display the communication characteristics.

9. The system of claim 1, wherein the network managing node is further operable to transmit a warning message to one or more computer nodes, the warning message representing suspect network activity.

10. A method for managing resource sharing between a plurality of computer nodes of a network, comprising:
detecting a plurality of access rights from the computer nodes;
modifying the access rights;
storing the modified access rights in a directory service server;
detecting a plurality of hardware resource allocations from the computer nodes;
prioritizing the hardware resource allocations into one or more pools; and
storing the pools in the directory service server.

11. The method of claim 10, further comprising:
monitoring communication between the computer nodes; and
storing a plurality of communication characteristics representing the communication between the computer nodes.

12. The method of claim 11, further comprising displaying the communication characteristics.

13. The method of claim 11, wherein the communication characteristics are indicative of resource sharing between two or more computer nodes.

14. The method of claim 11, wherein a communication characteristic is selected from the group consisting of the identity of two computer nodes communicating with each other, the identity of two computer nodes that have communicated, the identity of a first computer node using the hardware resource of a second computer node, a time period representing how long a first computer node used a second computer node's hardware resource, a list of searchable directories, a list of access rights, and a list of available hardware resources.

15. The method of claim 10, further comprising intermittently repeating the modifying and prioritizing steps.

16. The method of claim 10, further comprising modifying the modified access rights and the pools.

17. A method for managing resource sharing between a plurality of computer nodes of a network, comprising:
receiving a command from a user of a first computer node to store an electronic file in a directory of the first computer node;
automatically encrypting, after receiving the command, the electronic file with a private key;
storing the electronic file in the directory;
receiving a file request from a second computer node requesting the electronic file;
accessing a directory service server coupled to the plurality of computer nodes;
identifying, by the directory service server, whether the second computer node has access rights to the directory;
if the second computer node has access rights to the directory, then:
establishing an encryption link;
transferring the electronic file over the encryption link; and
redirecting the second computer node to an encryption service server so that the second computer node can obtain a public key for the electronic file; and
if the second computer node does not have access rights to the directory, then:
denying the second computer node access to the electronic file; and
sending a message to the second computer node indicating the denial.

18. The method of claim 17, further comprising creating an index file representative of the electronic files stored in the directory.

19. The method of claim 17, further comprising sending a plurality of access rights to a network managing node, the access rights indicative of which computer nodes of the plurality of computer nodes have access to the directory.

20. The method of claim 17, further comprising:
allocating a portion of a hardware resource of the first computer node for use by other computer nodes; and
sending an indication of the hardware resource allocation to a network managing node.

21. The method of claim 20, further comprising:
receiving a hardware resource request from a second computer node requesting the allocated portion of the hardware resource;
establishing an encryption link;
receiving information over the encrypted link from the second computer node;
processing the information with the allocated portion of the hardware resource; and
sending the processed information to the second computer node over the encrypted link.

22. A method for managing resource sharing between a plurality of computer nodes of a network, comprising:
receiving a command from a user of a first computer node to allocate a portion of a hardware resource of a first computer node;
sending the hardware resource allocation to a network managing node;
receiving a hardware resource request from a second computer node requesting the allocated portion of the hardware resource;
establishing an encryption link;
receiving information over the encrypted link from the second computer node;
processing the information with the allocated portion of the hardware resource; and
sending the processed information to the second computer node over the encrypted link.

23. The method of claim 22, further comprising:
receiving a second command from the user to store an electronic file in a directory of the first computer node;
automatically encrypting, after receiving the second command, the electronic file with a private key;
storing the electronic file in the directory;
receiving a file request from the second computer node requesting the electronic file;
accessing the directory service server;
identifying, by the directory service server, whether the second computer node has access rights to the directory;
if the second computer node has access rights to the directory, then:
establishing a second encryption link;
transferring the electronic file over the second encryption link; and
redirecting the second computer node to an encryption service server so that the second computer node can obtain a public key for the electronic file; and
if the second computer node does not have access rights to the directory, then:
denying the second computer node access to the electronic file; and
sending a message to the second computer node indicating the denial.

24. The method of claim 23, further comprising creating an index file representative of the electronic files stored in the directory.

25. The method of claim 23, further comprising sending a plurality of access rights to the network managing node, the access rights indicative of which computer nodes of the plurality of computer nodes have access to the directory.
